(19) United States
(12) Patent Application Publication
(10) Pub. No.: US 2020/0158076 A1
(43) Pub. Date: May 21, 2020

(54) HYDROPOWER PLANT FOR CONTROLLING GRID FREQUENCY AND METHOD OF OPERATING SAME

(71) Applicant: VOITH PATENT GMBH, HEIDENHEIM (DE)

(72) Inventors: THOMAS FOITZIK, NEULER (DE); MARTIN BRUNS, HEIDENHEIM (DE)

(21) Appl. No.: 16/604,896

(22) PCT Filed: Mar. 29, 2018
(86) PCT No.: PCT/EP2018/058121

§ 371 Date: Oct. 11, 2019

(30) Foreign Application Priority Data
Apr. 13, 2017 (DE) 10 2017 107 992.0
Aug. 10, 2017 (DE) 10 2017 118 194.6

(51) Int. Cl. F03B 13/08; H02P 9/02; H02K 11/04; H02K 7/18

(52) U.S. Cl. CPC F03B 13/08; H02K 7/1823; H02K 11/046; H02P 9/02

(57) ABSTRACT

A hydropower plant for regulating the frequency of an electric grid has an upper water reservoir, a lower water reservoir, and a waterway that connects the upper water reservoir to the lower water reservoir. A turbine is arranged in the waterway and includes a runner, a guide vane apparatus and a device for blowing out the runner space. An electric double-fed asynchronous machine is mechanically connected to the turbine and a frequency converter is electrically connected to the asynchronous machine. A mains transformer is electrically connected to the asynchronous machine, frequency converter and mains grid. A resistor is arranged in a DC intermediate circuit of the frequency converter in such a way that it may connect the line sections of the DC intermediate circuit to one another. There is also provided a device for cooling the resistor.

The present invention relates to a hydropower plant suitable for rapidly controlling the grid frequency, and to a method for operating such a hydropower plant.

Due to the inertia of the water column and the maximum and minimum permissible water pressure in the waterways and turbine, classical hydropower plants may only control electrical power relatively slowly—typically on a timescale of 10-30 seconds. This is not sufficient to contribute to short-term control of the grid frequency in view of increased requirements. For example, the National Grid Code of Great Britain requires that a certain electrical power must be applied to the grid or absorbed in less than a second, depending on the grid frequency, in order to participate in the corresponding compensation. The object of the present invention is to provide a hydropower plant that may provide control power on a timescale of less than one second. Another object of the present invention is to provide a method for operating such a hydropower plant.

The inventors have recognized that the specified objective may be accomplished by a hydropower plant with the features of claim 1. Advantageous embodiments are set forth in the dependent claims that depend from claim 1. The method according to the invention for operating such a hydropower plant is set forth in the independent method claim. Advantageous embodiments are set forth in the dependent method claims

The solution according to the invention is explained below with reference to the drawings. The drawings illustrate the following, specifically:

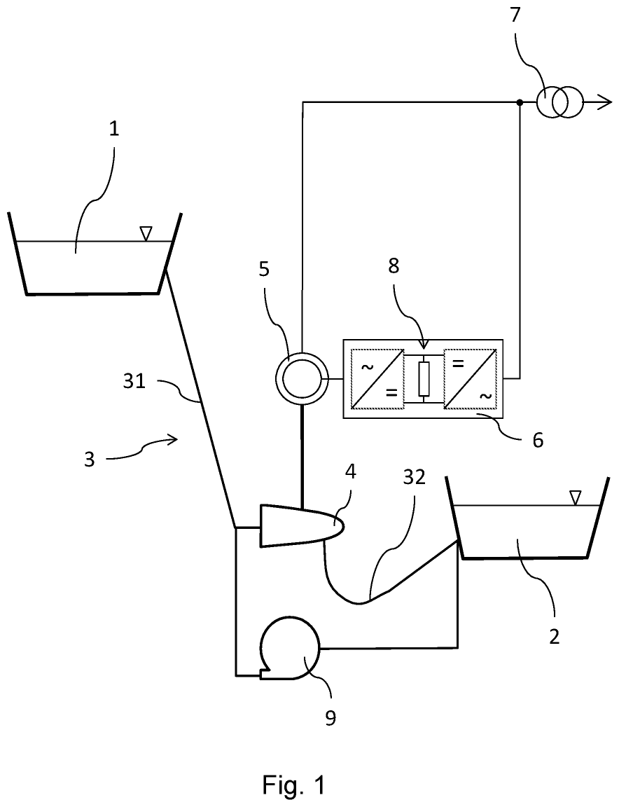

FIG. 1 Hydropower plant according to the invention;

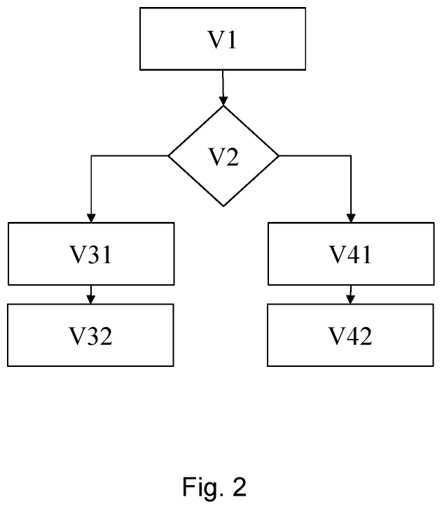

FIG. 2 Flow chart of the operation of a hydropower plant according to the invention.

FIG. 1 shows the schematic structure of a hydropower plant according to the invention. The hydropower plant comprises an upper water reservoir marked 1 and a lower water reservoir marked 2, the water surface of the upper water reservoir 1 being above the water surface of the lower water reservoir 2. The reservoirs 1 and 2 may also be natural waters, for example lakes or rivers. The hydropower plant also comprises a waterway marked 3 that connects the upper water reservoir 1 with the lower water reservoir 2. A turbine marked 4 is arranged in the waterway 3. The waterway 3 is consequently divided into two parts. The part above the turbine 4—the pressure pipe—is marked 31, and the part below the turbine—the draft pipe—is marked 32. The turbine 4 has a turbine runner, a guide vane apparatus and a device for blowing out the space around the turbine runner so that when blown out the turbine runner may rotate in air, with the closed guide vane apparatus preventing the air from escaping toward the upper water reservoir. The turbine may optionally be equipped with additional closing members, for example a ball valve, in addition to the guide vane apparatus. The turbine 4 is coupled to an double-fed asynchronous machine marked 5. The double-fed asynchronous machine 5 comprises a rotor and a stator. The rotor of the double-fed asynchronous machine 5 is electrically connected to a frequency converter marked 6. The frequency converter 6 is connected to the mains grid via a mains transformer marked 7. The stator of the double-fed asynchronous machine is directly connected with the transformer 7.

There is a resistor in the DC intermediate circuit of the frequency converter 6 that may be switched in such a way that it connects the line sections of the DC intermediate circuit with each other. The resistor is marked with 8. The hydropower plant also optionally comprises at least one pump that is marked with 9 and is arranged to pump water from the lower water reservoir 2 into the upper water reservoir 1. The pump 9 may comprise its own closing members and has its own independent drive with a mains connection.

FIG. 2 shows a schematic flowchart method according to the invention for operating a hydropower plant according to the invention. In the step marked V1, the hydropower plant is in the following state: The runner of the turbine 4 is blown out so that it may rotate in air. The double-fed asynchronous machine 5 runs in phase-shifter mode, i.e. the rotor thereof rotates according to the grid frequency (i.e. within the permissible slip band) and, depending on the excitation state, reactive power may be supplied to the mains grid either capacitively or inductively. Due to the coupling of the double-fed asynchronous machine 5 and the turbine 4, the runner of the turbine 4 rotates at the same rotational speed as the rotor of the double-fed asynchronous machine 5. In the step marked V2, a request is sent to the hydropower plant to actively provide fast control power. The request may be to quickly deliver power to the grid or to quickly receive power from the mains grid. In the first case, the steps on the left branch of the flow chart are followed; in the second case the steps on the right branch are followed.

Power output to the mains grid: In the step marked V31, the double-fed asynchronous machine 5 and connected turbine 4 are braked via the frequency converter 6. The energy stored in the angular momentum of the rotating components is output to the mains grid. The procedures that take place in step V31 are very fast and therefore the requested power may be delivered to the mains grid in less than one second. In the step marked V32, the guide vane apparatus is opened, together with other closing members of the turbine 4 if applicable. This allows water to enter the previously blown-out area around the runner of the turbine 4 from the upper water 1. The air is expelled in the direction of the lower water reservoir 2. The water flow accelerates the turbine 4 and the double-fed asynchronous machine 5 back to a higher speed; thus, power may be durably output to the mains grid. The procedures of step V32 are initiated simultaneously with the procedures of step V31. However, because the procedures of step V32 are much slower than those of step V31, they only become effective much later—usually after approximately 15-20 seconds. Before this, the power output to the mains grid is determined by the procedures of step V31. In step V31, the power output to the mains grid is controlled by the frequency converter 6; in step V32, it is controlled by the controller of the turbine 4 with the aid of the guide vane apparatus.

Power absorption from the mains grid: In the step marked V41, the frequency converter 6 draws power from the mains grid. This power is converted into heat via the resistor 8. For this purpose, the resistor 8 must be cooled. It is advantageous if part of the power that the frequency converter 6 draws from the mains grid is used to accelerate the double-fed asynchronous machine 5 and the runner of the turbine 4. Thus less energy needs to be converted into heat in the resistor 8. The procedures in step V41 are very fast and therefore the required power may be absorbed from the mains grid in less than one second. The procedures described in step V41 may in principle be used by themselves to absorb power from the mains grid over a longer period of time alone. However, energy is constantly converted into heat and thus, as it were, destroyed. It is accordingly advantageous if the energy is only briefly converted into heat in V41. In the optional step marked V42, the optional pump 9 is started up in order to pump water from the lower water reservoir 2 to the upper water reservoir 1. As a result, additional power is absorbed from the mains grid and the energy that the pump 9 absorbs is converted into potential energy of the water and stored for later use in turbine operation. The procedures of step V42, in this case, are initiated simultaneously with the procedures of step V41. Because the procedures of step V42 are much slower than those of step V41, however, these procedures take longer to come to bear—usually after approximately 10 to 15 seconds. Before this, the power absorption from the mains grid is determined by the procedures of step V41. In step V41, the frequency converter 6 controls power absorption from the mains grid. In step V42, power absorption from the mains grid may be controlled in two ways: Either the pump 9 has a variable speed drive that is able to control the power that the pump 9 absorbs, or the pump 9 is designed as a constant speed pump. In the latter case, the frequency converter 6 controls the power absorbed from the mains grid. The guide vane apparatus of the turbine 4 is used for speed control. The double-fed asynchronous machine 5 produces a corresponding electrical power that is fed into the grid. The result is a situation known as a hydraulic short circuit. The net power that the mains grid absorbs is then calculated from the pump power minus the power that the double-fed asynchronous machine 5 produces. Plainly, the power that the double-fed asynchronous machine 5 generates must be less than the pump power. Because the frequency converter 6 is able to control the turbine power and thus the power that the double-fed asynchronous machine 5 generates, the net power absorption from the mains grid may also be controlled.

After processing the request made in step V2 to provide fast control power, the hydropower plant is returned to the operating state described in step V1. The hydropower plant is then once again ready to respond to another request.

Practical experience in designing a hydropower plant according to the invention has shown that it is advantageous if in step V31 the double-fed asynchronous machine 5 is braked to the minimum permissible speed. It is also advantageous if the double-fed asynchronous machine 5 is accelerated to the maximum permissible speed in step V41. The frequency converter 6 may be designed as a “Voltage Source Inverter” (VSI). A VSI has the advantage that it enables power factor control as well as control in what is referred to as “Low Voltage Ride Through.”

In order for the hydropower plant to be able to optimally provide control power as the Grid Code requires, the plant must be designed in such a way that the capacity for power output to the grid corresponds to the capacity for power absorption from the grid. This requirement must be met over both the short and the long term. The design of the hydropower plant according to the invention is sufficiently flexible that this requirement may be met by an appropriate design of the components.

1-12. (canceled)

13. A hydropower plant for regulating the frequency of an electric grid, the hydropower plant comprising:
an upper water reservoir and a lower water reservoir, wherein a water level of the upper water reservoir lies above a water level of the lower water reservoir;
a waterway connecting the upper water reservoir with the lower water reservoir;
a turbine arranged in the waterway, the turbine including a runner, a guide vane apparatus and a device for blowing out a runner space;
an electric double-fed asynchronous machine mechanically connected to the turbine, the double-fed asynchronous machine including a rotor and a stator;
a frequency converter electrically connected to the rotor of the double-fed asynchronous machine, the frequency converter having a DC intermediate circuit;
a mains transformer electrically connected to the frequency converter, to the stator of the double-fed asynchronous machine and to the mains grid;
a resistor arranged in the DC intermediate circuit of the frequency converter and configured to connect line sections of the DC intermediate circuit to one another; and
a device for cooling the resistor.

14. The hydropower plant according to claim 13, further comprising a pump for pumping water from the lower water reservoir into the upper water reservoir, the pump having an independent drive.

15. The hydropower plant according to claim 14, wherein the pump comprises a variable speed drive.

16. The hydropower plant according to claim 14, wherein the pump comprises a drive with constant speed.

17. The hydropower plant according to claim 13, wherein the frequency converter is a voltage source inverter (VSI).

18. A method of operating a hydropower plant, the method comprising:
providing a hydropower plant according to claim 13;
in a step V1, blowing out the runner of the turbine and operating the double-fed asynchronous machine in phase-shifter mode;
in a step V2, receiving a request for the hydropower plant to provide fast control power, thereby:
if power output is requested:
in a step V31, braking the double-fed asynchronous machine with the frequency converter;
in a step V32, opening the guide vanes of the turbine and starting controlled turbine operation;
if power absorption is requested:
in a step V41, absorbing with the frequency converter power from the mains grid and causing the resistor to convert energy into heat.

19. The method according to claim 18, further comprising, if power absorption is requested: in a step V42, starting the pump and starting controlled pump operation.

20. The method according to claim 18, wherein step V41 comprises accelerating the double-fed asynchronous machine with the frequency converter.

21. The method according to claim 18, wherein step V31 comprises braking the double-fed asynchronous machine to a minimum permissible rotational speed.

22. The method according to claim 18, wherein step V41 comprises accelerating the double-fed asynchronous machine to a maximum permissible rotational speed.

23. The method according to claim 22, which comprises accelerating the double-fed asynchronous machine with the frequency converter.

24. The method according to claim 18, which comprises providing the hydropower plant with a pump for pumping water from the lower water reservoir into the upper water reservoir, the pump having an independent, variable speed pump drive, and controlling the controlled pump operation in step V42 with the variable speed pump drive.

25. The method according to claim 18, which comprises providing the hydropower plant with a pump for pumping water from the lower water reservoir into the upper water reservoir, the pump having constant speed drive, and wherein step V42 comprises opening the guide vane apparatus of the turbine and controlling the controlled pump operation by the frequency converter and the guide vane apparatus of the turbine, wherein the turbine and the pump are in a hydraulic short circuit.
